(19) United States
(12) Patent Application Publication
(10) Pub. No.: US 2014/0196610 A1
(43) Pub. Date: Jul. 17, 2014

(54) APPARATUS AND METHOD FOR COOKING POULTRY AND FOWL

(71) Applicant: Jamie RAYKO, Celebration, FL (US)

(72) Inventor: Jamie RAYKO, Celebration, FL (US)

(21) Appl. No.: 13/743,084

(22) Filed: Jan. 16, 2013

(51) Int. Cl. A47J 37/01

(52) U.S. Cl. CPC A47J 37/01
USPC 99/345

(57) ABSTRACT

An apparatus for cooking poultry and fowl includes a longitudinally elongated upstanding main body having a plurality of side walls and an elongated angled beam secured to the bottom wall. A pair of wing shelves are disposed along the side walls and a generally V-shaped channel is disposed along an upper surface if the beam.

An apparatus for cooking poultry and fowl also includes a plurality of openings disposed within the entirety of the main body.

### TECHNICAL FIELD

The present invention relates generally to bake ware, and more particularly to an improved container for cooking poultry and fowl.

### BACKGROUND

The statements in this section merely provide background information related to the present disclosure and may not constitute prior art.

As any home or professional chef will attest, cooking a moist turkey, whole chicken or other fowl takes a lot of work and constant attention. This is because turkeys are traditionally cooked in a deep pan wherein the breast is facing up, and the back of the turkey and wings are placed against the bottom of the pan. When cooking, basting juices are contained within the pan and are absorbed into the bird throughout the cooking process.

As such, the back portion of the bird, which contains mostly dark meat, is constantly submerged within the juices, and the upper portion of the bird containing the prized breast and white meat must be constantly basted. Even so, the end result is that white meat is typically noticeably dryer than the dark meat.

For these reasons, alternate methodologies have been attempted to achieve a more juicy white meat portion. Several examples include deep frying the bird and placing the bird face down into the pan. With regard to deep frying, the entire turkey is submerged in grease and is cooked quickly to retain moisture. While this achieves a moist bird, there is a health problem associated with the grease, thus rendering an otherwise healthy meal extremely unhealthy.

With regard to cooking the bird face down, conventional cooking pans are not designed to provide adequate support for the bird in a face down orientation. To this end, when the breast makes direct contact with the bottom of the pan, the meat tends to become stuck during cooking and can tear off when trying to remove. Additionally, as the bird cooks and becomes moist, the wings and other portions of the bird often become soft and fall off. Whenever this occurs, the bird does not cook evenly and cannot be displayed whole on a platter such as a Thanksgiving Day tray, for carving at the table.

Accordingly, there remains a need for an apparatus and method for cooking poultry and fowl that does not suffer from the above drawbacks.

### SUMMARY OF THE INVENTION

The present invention is directed to an apparatus for cooking poultry and fowl. One embodiment of the present invention can include a longitudinally elongated upstanding main body having a plurality of side walls and an elongated angled beam secured to the bottom wall. A pair of wing shelves is disposed along the side walls and a generally V-shaped channel is disposed along an upper surface if the beam. The beam and shelves acting to support a turkey in a face down orientation and to allow basting juices contained within the curved bottom wall to be absorbed into the same.

Another embodiment of the present invention can include a plurality of openings disposed within the entirety of the main body in order to allow the apparatus to be removably inserted into a conventional roasting pan.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view an apparatus for cooking poultry and fowl in accordance with one embodiment of the invention.

FIG. 2 is a side view of the apparatus for cooking poultry and fowl in accordance with one embodiment of the invention.

FIG. 3 is an end side view of the apparatus for cooking poultry and fowl in accordance with another embodiment of the invention.

FIG. 4 is a side view of the apparatus for cooking poultry and fowl in operation, in accordance with one embodiment of the invention.

FIG. 5 is a perspective view of the apparatus for cooking poultry and fowl in accordance with an alternate embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

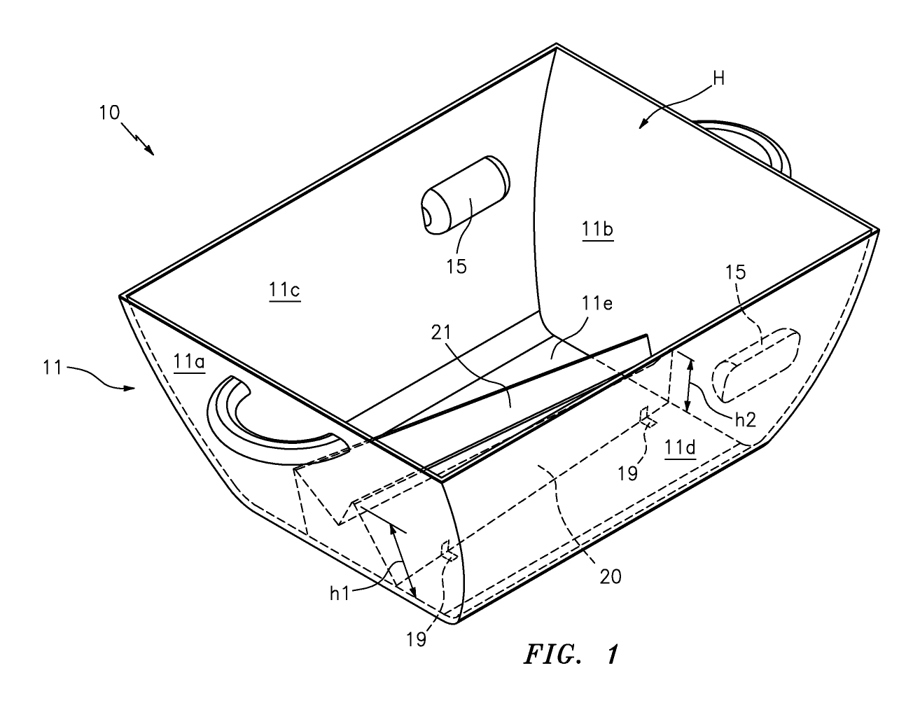

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

Although described throughout this document as cooking a turkey, this is for illustrative purposes only, as the inventive concepts described herein can be applied to any type of food wherein basting is traditionally employed. Several non-limiting examples include fowl, poultry and roasts, for example.

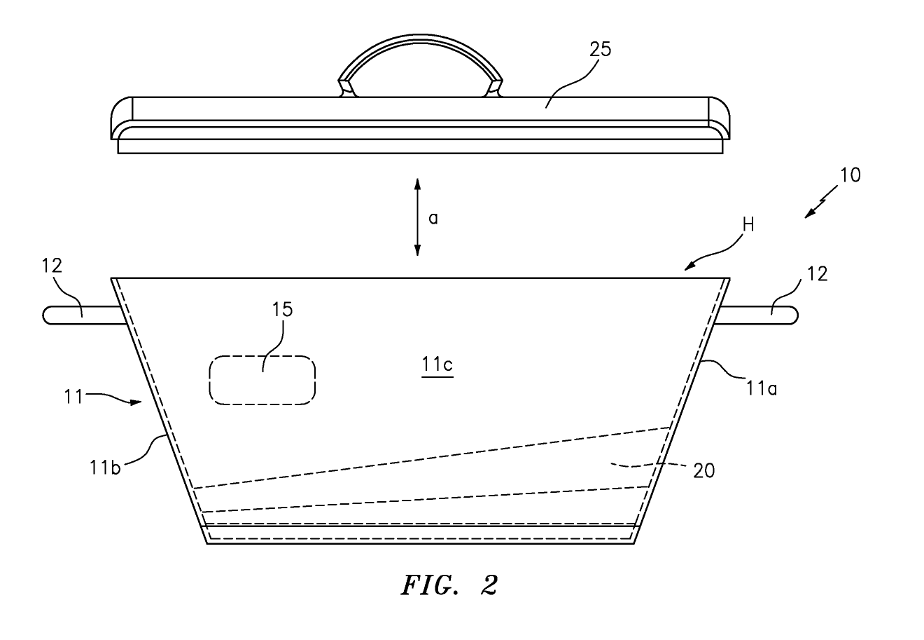

FIGS. 1 and 2 illustrate one embodiment of an apparatus for cooking poultry and fowl 10 that is useful for understanding the inventive concepts disclosed herein. As shown, the container can include a longitudinally elongated, upstanding main body/pan 11 designed to hold poultry and fowl such as turkey, for example. The main body 11 including a first end 11a, a second end 11b, a pair of opposing curved side walls 11c and 11d and a curved bottom wall 11e. As shown, each of the bottom, end and side walls are joined along their common edges so as to form an impervious interior space H for receiving the bird and containing the basting juices.

The main body 11 is preferably constructed from a strong, lightweight material such as steel or ceramic, for example, that is capable of withstanding the rigors of repeated usage and exposure to extremely high heat. Alternatively, however, the main body can also be constructed from a less durable material such as aluminum, for example that is capable of being used one time before being discarded.

Although illustrated as including a generally rectangular upper surface area, those of skill in the art will recognize that the main body 11 can be constructed in any number of different shapes, and can be scaled to accommodate birds of varying sizes and weights, without limitation.

An elongated beam 20 can be secured to the bottom surface 11e, and extend from the first end 11a to the second end 11b. As shown, the top of the beam can preferably include a generally V-shaped channel 21, and the beam itself can preferably be angled at approximately 45 degrees across the bottom surface of the pan such that vertical height h1 at the first end is greater than the vertical height h2 at the second end.

A pair of inward radiating protrusions 15 (i.e., wing shelves) can be secured along the inside portion of side walls 11c and 11d at a location near the second side wall 11b, and above the lower portion h2 of the elongated beam 20. The protrusions 15 working in unison to receive and support the wings of an inserted turkey that is being cooked in a face down orientation.

As will be described below in detail, the wing shelves 15 and the elongated angled beam 20 can act to securely receive and position a turkey within the pan in a face down orientation without causing damage to the bird. The groove within the V-channel further acting to allow moisture to make contact with the bird along the majority of the breast area. More specifically, instead of resting the bird on a flat surface wherein a large portion of the bird is making direct contact with the pan, and can therefore become stuck, the V-channel provides two small lines of direct contact with the bird, and allows the remainder of the bird to be in direct contact with the cooking juices. Additionally, the angle of the V channel ensures that the breast meat will always remain in contact with the juices.

Each of the protrusions 15 and the beam 20 can also be constructed from a sturdy material such as metal, for example and can be permanently secured to the main body utilizing any number of conventional techniques such as welds, adhesives and the like. Alternatively, one or more of the protrusions 15 and beam 20 can be integrated into the construction of the apparatus so as to be formed from a single piece of material. However, in an alternate embodiment, the beam 20 can be removably secured to the bottom wall of the main body via one or more clips 19, or other conventional means of attachment, for example. Of course, any number of other materials such as ceramic and aluminum, for example, as well as other construction methodologies can also be utilized herein.

As illustrated in FIG. 2, the main body can further include a pair of handles 12 which are secured to the end walls 11a and 11b. Additionally, a removable lid 25 having a complementary dimension to the upper portion of the main body 11 can also be provided. The lid acting in a conventional manner, so as to be placed, see arrow a, on top of the main body in order to completely enclose the interior space H.

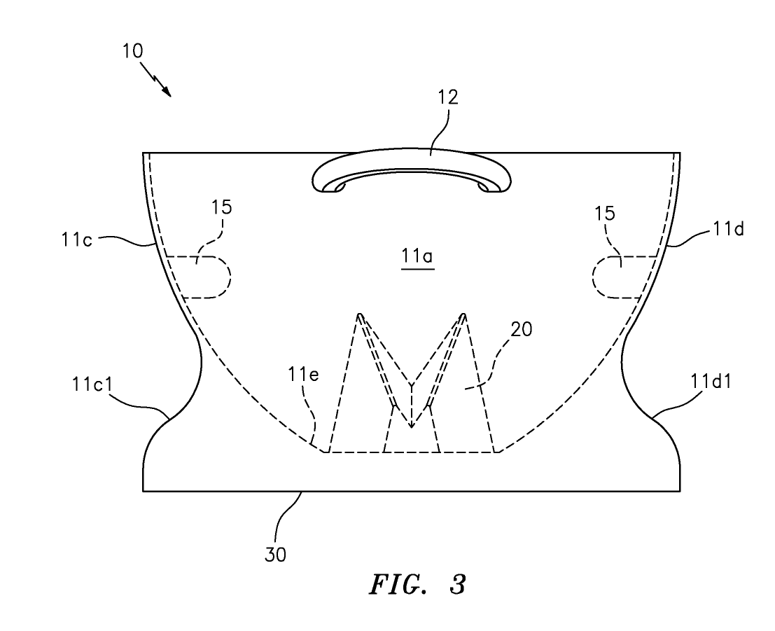

FIG. 3 illustrates an alternate embodiment of the apparatus 10, wherein the outside portions of each of the side walls 11c and 11d include a generally hourglass shape having an outer radiating bend 11c1 and 11d1, respectively, until terminating along a generally planar outside facing bottom surface 30. Such a feature can provide an extremely stable base so as to prevent the apparatus from accidentally falling over during use.

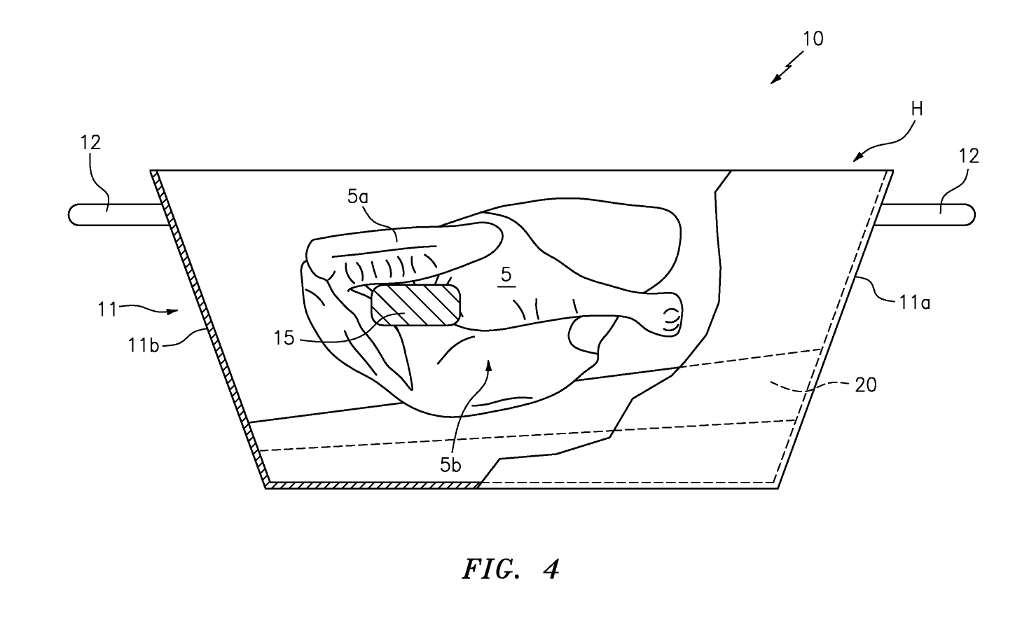

FIG. 4 illustrates one embodiment of the apparatus 10 in operation wherein a turkey 5 is lowered into the interior space H of the pan 11 in a face down orientation until coming to rest upon the V-shaped channels of the beam 20. When so positioned, the wings 5a of the bird can be held in place by the wing shelves 15 so as to ensure the bird is fully supported during cooking. As shown, the curved bottom and side walls 11c-11e, along with the recessed portion of the V-channel act as a pool for positioning the basting juices around the breast of the bird. Such a feature allows the bird to be evenly cooked in a face down orientation wherein the white meat always remains in contact with the juices, and does not require basting.

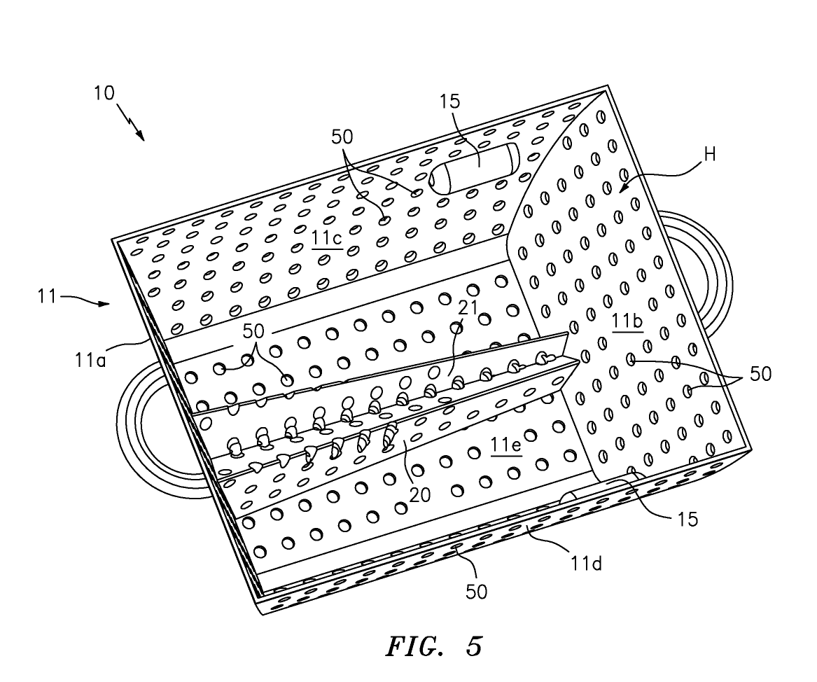

FIG. 5 illustrates an alternate embodiment of the apparatus 10 that further includes a plurality of holes, openings and/or perforations 50 that are disposed along the entirety of the main body 11 and/or the beam 20. In the present embodiment, the perforations act in conjunction with the main body and brace to position a turkey in a face down orientation, and allow the entire apparatus 10 to be removably inserted into a conventional roasting pan 9, as shown by arrow b. To this end, when inserted into the roasting pan 9, the basting liquids can be retained within the pan 9 and can flow through the openings 50 to make contact with the bird, as described above. When the bird is fully cooked, the entire apparatus 10 can then be removed via the handles 12 and the basting juices can drain through the openings 50 and remain within the roasting pan. Such a feature allows the inventive concepts disclosed herein to be utilized by traditional roasting pans.

As described herein, one or more elements of the apparatus for cooking poultry and fowl 10 can be secured together utilizing any number of known attachment means such as, for example, screws, glue, compression fittings and welds, among others. Moreover, although the individual elements of both the apparatus have been described separately, the inventive concepts disclosed herein are not so limiting. To this end, one of skill in the art will recognize that each of the main body 11, wing shelves 15 and/or the beam 20, for example, can be formed together as one continuous element, either through manufacturing processes, such as welding, casting, or molding, or through the use of a singular piece of material milled or machined with the aforementioned components forming identifiable sections thereof.

Accordingly, the apparatus for cooking poultry and fowl 10 can include any number of different shapes, sizes and construction materials acting in unison to position poultry or fowl in a face down orientation wherein the white meat always remains in contact with the juices and does not require basting.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus for cooking poultry and fowl, said apparatus comprising:
a longitudinally elongated upstanding main body having a first end, a second end, and a pair of opposing side walls, each terminating along a bottom end into a generally curved bottom wall, said walls forming an impervious interior space;
an elongated angled beam secured to the bottom wall, said beam extending from the first end of the main body to the second end of the main body, said beam including a generally V-shaped channel disposed along an upper surface, and being configured to receive and support at least one of a poultry and fowl in a face down orientation; and
a protrusion disposed onto an inside portion of each of the opposing side walls, said protrusions being configured to receive and support a wing of the at least one received poultry and fowl,
wherein the interior space of the main body is configured to retain a basting liquid during a cooking procedure.

2. The apparatus of claim 1, wherein the beam is positioned along the bottom wall at an approximately 45 degree horizontal angle, and includes a lower end and an upper end.

3. The apparatus of claim 1, wherein each of the side wall protrusions are positioned above the lower end of the beam, and adjacent to the second end of the main body.

4. The apparatus of claim 1, wherein the main body is constructed from at least one of a metal, and ceramic material that is configured to be repeatedly used.

5. The apparatus of claim 1, wherein the main body is constructed from a single mold of thin aluminum that is and configured for one time usage.

6. The apparatus of claim 1, further comprising:
a pair of handles configured to allow movement of the apparatus.

7. The apparatus of claim 1, further comprising:
a removable lid configured to be secured to an upper portion of each of the first end, the second end, and the opposing side walls.

8. The apparatus of claim 1, further comprising:
an elongated, generally planar outside facing bottom surface, said outside facing surface being configured to allow the apparatus to stand upright in a secure manner.

9. The container of claim 1, wherein each of the beam and the side protrusions are integrally formed into the construction of the main body.

10. An apparatus for cooking poultry and fowl, said apparatus comprising:
a longitudinally elongated upstanding main body having a first end, a second end, and a pair of opposing side walls, each terminating along a bottom end into a generally curved bottom wall;
a plurality of openings disposed along the entirety of the main body, said openings being configured to allow a basting liquid to be deposited and removed from an interior portion of the main body;
an elongated angled beam secured to the bottom wall, said beam extending from the first end of the main body to the second end of the main body, said beam including a generally V-shaped channel disposed along an upper surface, and being configured to receive and support at least one of a poultry and fowl in a face down orientation; and
a protrusion disposed onto an inside portion of each of the opposing side walls, said protrusions being configured to receive and support a wing of the at least one received poultry and fowl.

11. The apparatus of claim 10, wherein the beam is positioned along the bottom wall at an approximately 45 degree horizontal angle, and includes a lower end and an upper end.

12. The apparatus of claim 10, wherein each of the side wall protrusions are positioned above the lower end of the beam, and adjacent to the second end of the main body.

13. The apparatus of claim 10, wherein the main body is constructed from at least one of a metal, and ceramic material that is configured to be repeatedly used.

14. The apparatus of claim 10, wherein the main body is constructed from a single mold of thin aluminum that is and configured for one time usage.

15. The apparatus of claim 10, further comprising:
a pair of handles configured to allow the apparatus to be removably deposited into a conventional basting pan.

16. The container of claim 10, wherein each of the beam and the side protrusions are integrally formed into the construction of the main body.
